(19) United States
(12) Patent Application Publication
(10) Pub. No.: US 2007/0187042 A1
(43) Pub. Date: Aug. 16, 2007

(54) Automatic hurricane, light and burglary protection system

(76) Inventor: Christer Kallstrom, Naples, FL (US)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(21) Appl. No.: 11/352,976

(22) Filed: Feb. 13, 2006

(51) Int. Cl. E05F 15/20

(52) U.S. Cl. 160/7

(57) ABSTRACT

An automatic protective shutter system that is controlled by atmospheric and or human intervention conditions. The shutter consists of a net that can be deployed automatically to cover any opening in a building structure. The shutter net can withstand high winds such as are prevailing winds in a hurricane. The shutter net can also withstand any projectiles that are being encountered in a hurricane. The shutter also protects against the incidence of high ultraviolet UV rays and/or excessive light. The shutter net also detects any tampering by a burglar or vandalism to shut down the opening or to sound an audible alarm. The shutter system is also extremely useful as a shield against the intrusion of insects. The protective shutter system can be controlled locally or by a remote system. The remote system would include a computer system operating through the internet. All of the above can be detected by various sensors such a high wind sensors, ultraviolet sensors and proximity sensors. The shutter net itself has an established surface frequency that operates within tolerable limits to generate a signal when that frequency is disturbed or changed to indicate a disturbance.

### FIELD OF THE INVENTION

The present invention relates generally to protective shutter systems and, more particularly, to automated environmental and security oriented shutter systems.

### DESCRIPTION OF RELATED ART

Hurricane and other intense windstorms may cause significant property damage to homes and buildings and other structures. Specifically, strong winds may cause objects to become projectiles that have enough force to shatter windows of buildings. Thereafter, dangerous winds and rain can enter the buildings and cause costly damage throughout. Consequently, to minimize the damage of hurricanes and windstorms, many communities and insurance underwriters require hurricane shutters for the protection of the buildings.

Prior art hurricane shutters traditionally are constructed of resilient panels that are strong enough to resist projectiles and prevent them from shattering the underlying window. One such hurricane shutter is disclosed in U.S. Pat. No. 6,209,263 to Poirier. Drawbacks associated with the Poirier hurricane shutter and other shutters utilizing metal panels include, but are not limited to, the obstruction of outward visibility and the transmission of daylight onto the building when the shutter is in use. Other forms of prior art hurricane shutters include roll-up storm curtains. One such storm curtain is disclosed in U.S. Pat. No. 6,851,464 to Hudoba et al. Drawbacks associated with the Hudoba storm curtain include, but are not limited to, the obstruction of transmission of daylight and the ability to prevent criminal break-in.

Furthermore, hurricane shutters of the prior art are unable to protect the building if there is no person physically present to manually deploy the shutters. For example, if a homeowner is away from his or her home on vacation and a hurricane strikes, the homeowner either must contact a relative or a friend to deploy the shutters for them. However, reliance on others in an emergency may not always guarantee that the shutters will be deployed. For example, the friend or relative delegated to deploy the shutters may be preoccupied with attending to his or her own concerns during the time of the emergency. Alternatively, the homeowner must return to a dangerous storm in order to employ the shutters. This is unfeasible if the conditions are too severe or if the homeowner is in a geographic region remote from the affected home. In addition, the homeowner often cannot deploy the hurricane shutters as a precaution prior to leaving for an extended period (e.g. vacation) because the presence of shutters during clear weather may notify potential burglars that the homeowner is away from the premises and may not soon return to the home.

### SUMMARY OF THE INVENTION

Accordingly, there is a need to provide a protective shutter system that may be automatically deployed under certain environmental conditions of human intervention. Additionally, such a protective shutter should resist criminal break-ins and allow for light passage into the home when deployed. Furthermore, such a protective shutter system should be integrated into a communications system to allow a remote monitoring of the status of the protective system and the environmental conditions in the immediate area thereof.

The inventive shutter system is also useful for applications for safety, protective, and closure purposes such as windows, sliders, doors, walls, siding, perimeters, fencing, pool/screen enclosures, lanais, porches, entryways, breezeways, foyers, vestibules and the like, and other passageways, openings and enclosures applicable to residential and commercial buildings, as well as for barriers, fencing and perimeter uses independent of buildings and structures.

The foregoing need for an improved protection system for a home or any other structures is addressed in the present invention. The inventive protective shutter is of a somewhat rigid and durable construction while maintaining aesthetic functionality.

The protective shutter system is designed to withstand flying debris, ammunition and unlawful intruders. It is also important to note that the inventive shutter system prevents the intrusion of insects operating in the same manner as other well known screens in the insect prevention art. Additionally, the protective shutter system is designed to reduce ultraviolet rays penetration into the home. The protective shutter system may operate under the direction of a computer control that senses environmental changes and deploys the protective shutter accordingly. Furthermore, the protective shutter system may be integrated with the home's existing alarm system. The protective shutter system may also provide remote monitoring and deployment thereof of the status of the protective shutter system and the environmental conditions of the immediate area thereof.

The protective shield may also be useful in combination with an automotive convertible as a top cover as well as for protective, containing, restraining and closure covers for automobiles, trucks (including cargo and debris restraints), trailers (including debris restraints), and for recreational vehicles such as RV's etc., and for awnings, shades, shelters and barriers employed in both stationary and mobile circumstances.

These and other advantages of the present invention will be understood from the description of the preferred embodiments, taken with the accompanying drawings, wherein like reference numerals represent like elements throughout.

### BRIEF DESCRIPTION OF THE DRAWINGS

FIG. 1 is an exploded perspective view of an automatic shutter system in accordance with the present invention;

FIG. 2 is a perspective view of the automatic shutter system of FIG. 1 and components for the automatic shutter system;

FIGS. 3 and 4 are a perspective view of an alternative drive system for a shutter net of the automatic shutter system;

FIGS. 5-7 show a safety system for stopping the shutter drive when encountering an obstacle;

FIGS. 8 and 9 illustrate a different embodiment for stopping the shutter net when reaching its lowest position.

### DETAILED DESCRIPTION OF THE INVENTION

The present invention will now be described with reference to the accompanying figures. It is to be understood that the specific apparatus and system illustrated in the attached figures and described in the following specification is simply an exemplary embodiment of the present invention.

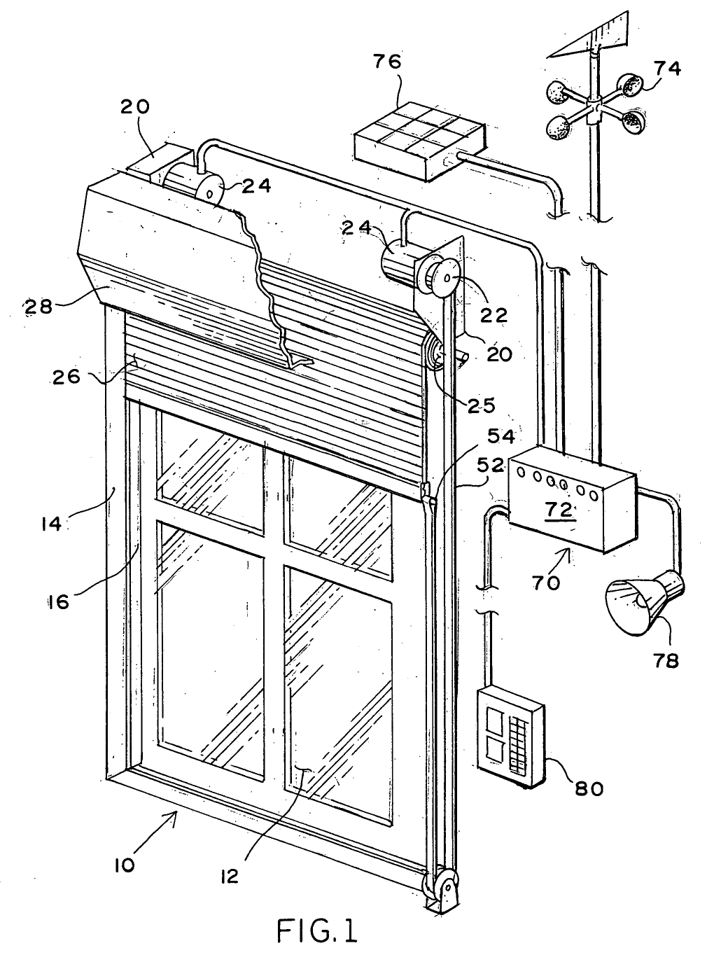

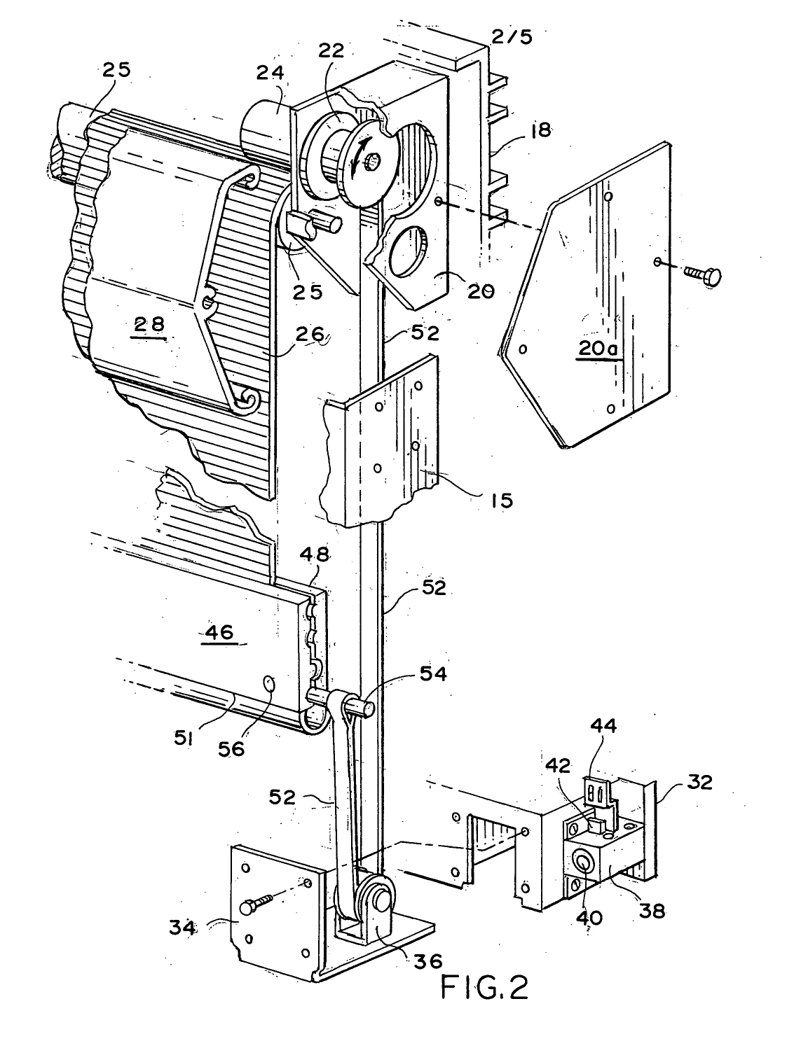

FIGS. 1 and 2 illustrate a shutter 10 system for use in a home, building or other structure and it is shown according to a desired embodiment of the invention. Desirably, the shutter system 10 is designed to fit over a window 12 (FIG. 2). Specifically, the shutter system 10 is positioned adjacent and parallel to the window 12 which would be covered upon deployment of the shutter 10. Although the present invention is discussed for use with windows, it is to be understood that the shutter 10 may be modified for use with sliding doors, doors or other outside access points. However, due to local ordinances or other fire safety restriction codes, such access points may be required to remain unobstructed.

The shutter 10 includes a left side guide profile 14 and a right side guide profile 15 or guide channels which are spaced parallel relative to each other. The space there between spans at least the width of the glass of the window 12. The left and right guide profiles 14 and 15 each include a groove or channel 16 extending the length of the respective profiles 14 and 15. An upper profile 18 is connected to a top portion of each of the guide profiles 14 and 15 and is secured thereto in a perpendicular orientation in relation to the left and right guide channels 14 and 15 to thereby create a frame. A mounting plate 20 is secured to each of the left and right guide profiles such that the mounting plates 20 extend beyond the top portion of each of the left and right guide channels. As shown in greater detail in FIG. 2, each mounting plate 20 is adapted to rotationally receive a top belt wheel 22. Each of the top belt wheels may be adapted to store potential energy via tension or compression loading members or springs therein when wound in one direction and held in a wound state. Upon release of the top band wheels 22, the potential energy is transferred into a rotational movement of the top band wheel 22 in an opposite direction.

A motor 24 is secured to each mounting plate such that each motor drives the respective band wheel 22. This may be accomplished by either a direct drive system in which the motor 24 is directly coupled with the top belt wheel 22 or by an indirect drive system in which the motor is configured to impart movement to the top belt wheel 22 by way of a gear or drive belt arrangement. An exemplary embodiment of the motor 24 is a tubular motor, however, it is to be understood that any suitably sized motor having sufficient power may be utilized. A rewind roller 25 is situated between each of the mounting plates 20 and 20a and extends substantially the length along the length of the upper profile 18. Desirably, the rewind roller 25 is adapted to store energy via tension or compression loading members or springs therein when wound in one direction and held in a wound state. Upon release of the rewind roller 25, the potential energy is transferred into a rotational movement of the rewind roller 25 in an opposite direction.

Attached or secured to the rewind roller 25 is a curtain or a net 26 which forms the basic shutter shield. The shutter net 26 is adapted to be wound to and unwound from the rewind roller 25. The shutter net 26 is desirably constructed of a woven composite material having high tensile strength such as aramid. Aramid composite material has a higher tensile strength modulus on a volume basis than steel. However, it is to be understood that other composite materials such as Kevlar may also be utilized. The high tensile strength of such composite material lends itself to providing a shutter net 26 that is relatively tear resistant and impervious to projectiles or sharp instruments. Accordingly, the shutter net or shield 16 of the present invention functions as a barrier and is conducive to preventing flying debris, ammunition and intruders from penetrating the shutter net 26 and, therefore, entering the home. The nature of the plastic material will allow the surface of the shutter net to “give” to some extent upon impact and will immediately recover because of its inherent plastic memory without being or staying distorted. For example, the shutter net 26 is rated to sustain winds of up to 146 mph. Because of the woven construction the net is not totally impervious to high winds. However, the air that is allowed to or will penetrate the net will immediately form a pressure barrier between the window surface behind it and itself and this barrier will resist or counter any higher pressures to enter to thereby avoid any damage to the opening it is designed to protect.

The screen is made of a woven net or shield of a weave having a density of 13.5 strands in the warp direction and about 10 in the weft/fill direction leaving about 32% of an open area made up of interstices between the warp and the weft directions. The warp consists of 1400-1500 denier of aramid fibers or strands and the weft strands consist of about 0.7 mm-1.1 mm steel wire consisting of a 7 strand multi-filament twisted twine wherein each of the filaments has a size of about 0.30 mm to 0.35 mm diameter.

In addition to projectile and wind resistance, the shutter 26 may be designed to inhibit the passage of ultraviolet radiation there through. Specifically, the woven composite material may include a coating in addition to the composite material that together prevent an estimated 80% of ultraviolet radiation from entering the home. The primary purpose of the coating is to prevent UV rays from degrading the chemical composition of the yarns or strands. Desirably, the shutter net mesh is semitransparent to allow unobstructed vision through the window even when the shutter is lowered. The shutter 26 may be constructed such that the semi-transparency of the shutter net 26 applies only in the context of an observer inside the home looking out.

As shown in greater detail in FIG. 2, an upper profile cap 28 having a substantially equal length and width of the upper profile 18 (FIG. 2) and is secured to each of the mounting plates 20 and the left and right side guide channels 14 and 15. A side cap 30 is secured to each of the mounting plates 20 so as to rest flush against respective ends of the upper profile cap 28. Accordingly, as shown in FIG. 2, the mounting plate 20, top band wheel 22 and the rewind roller are concealed behind the upper profile cap 28 and the side caps 30 to prevent a direct exposure to the elements and to provide an aesthetic appearance to the shutter system 10.

Referring once again to FIGS. 1 and 2, attached to the bottom of each of the left and right guide channels 14 and 15 is a housing 32. Each housing 32 is adapted to receive an end cover 34 to seal the bottom the bottom portion of the left and right guide channels 14 and 15. Each end cover 34 includes a lower band wheel 36 that is rotationally fixed to the housing 32. A magnetic lock 38 including a micro switch is secured to the housing 32 to provide a movement of the locking cylinder 40 from an extended position to a retracted position. A sensor 42 and a sensor plate 44 operating in conjunction therewith may be affixed to either housing 32 or the magnetic lock 38. Although not indicated in the drawings, it is to be understood that wiring is routed to the sensor 42 and the mechanical lock 38 to provide the electrical conductivity necessary for a proper functioning thereof.

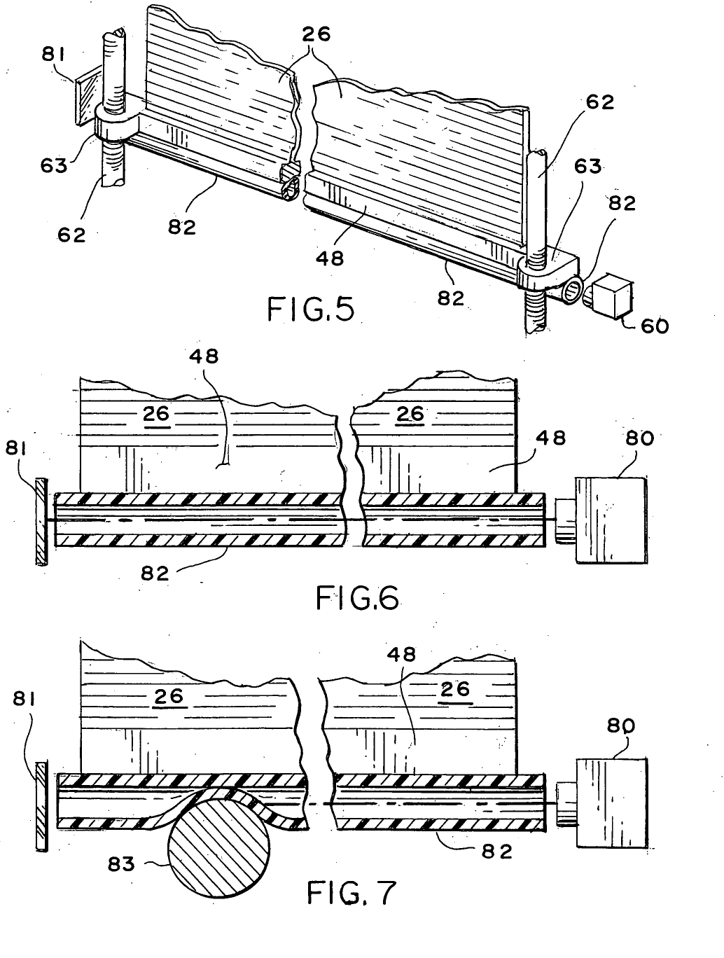

The shutter net 26 is designed to extend from the rewind roller 25 to at least a point below the glass of the window and onto a window sill, if present. With respect to the desirable embodiment of the present invention, A lower profile 46 is secured to a bottom edge of the shutter net 26 and a beam 48 is attached to the lower profile 46. This configuration is shown in greater detail in FIG. 5. Specifically, the beam 48 protrudes beyond the length of the lower profile 46 in each direction or on both sides in such a manner that the respective ends 50 and 51 are secured within the left and right guide channels 14 and 15. Accordingly, the ends 50 and 51 that are secured within the left and right guide channels allows the beam 48 and, consequently, the attached lower profile 46 to move along or within the left and right guide channels 14 and 15. The shutter net is therefore enabled to move up and down from a raised position to a lowered position and to every position there between. When the shutter net 26 is in a closed position, the lower profile 46 extends between the housings 32 and is flush with a bottom portion thereof. As the shutter net 26 is moved into a raised position, the lower profile also moves upwardly between the left and right guide channels 14 and 15.

As shown in FIGS. 1, 3 and 6, to effectuate the movement of the shutter net 26, respective belts 52 are secured from their respective top band wheels 22, are guided around the lower band wheels 36, and secured to pins 54 extending from the beam 48. In operation, when the shutter net 26 is in a raised position, rotational movement imparted by the motors 24 coupled to the top band wheels will cause the winding of the respective bands 52 thereon. Consequently, the shutter net 26 is unwound from the rewind roller 25 as potential energy is stored in the tension or compression loading members thereof. Upon reaching a lowered position, the respective magnetic locks 38 may be activated to cause the locking cylinders 40 to engage corresponding holes 56 in the lower profile 46 and effectively lock the shutter net 26 in the lowered position. The sensor 42 via the sensor plate 44 is configured to determine whether the shutter net 26 is actually in the lowered position. Upon disengagement of the locking cylinders 40 from the holes 56, the shutter net 26 is wound onto the rewind roller 25 until the shutter net 26 returns to a raised position.

Desirably, the structural components of the shutter including, but not limited to, the left and right guide channels 14 and 15, the upper profile 18, the upper profile cap 28 and the side caps 20 are constructed of metal or other sturdy material. These structural components are preferably of a unitary construction to provide increased strength. Such components may be molded. extruded or machined into the appropriate dimensions. Additionally, because the shutter 10 is exposed to the elements, it may be desirable to construct the components of a rust-resistant material such as aluminum or plastics. However, it is to be understood that any suitable material may be utilized. It is also to be understood that the fastening and securing of the aforementioned components may be implemented in a variety of ways. Desirably, for ease of assembly, the majority of the components are secured to one another via screws, however, it is still further to be understood that the securing techniques or implements may be utilized including, but not limited to rivets, glues, welding and friction fit.

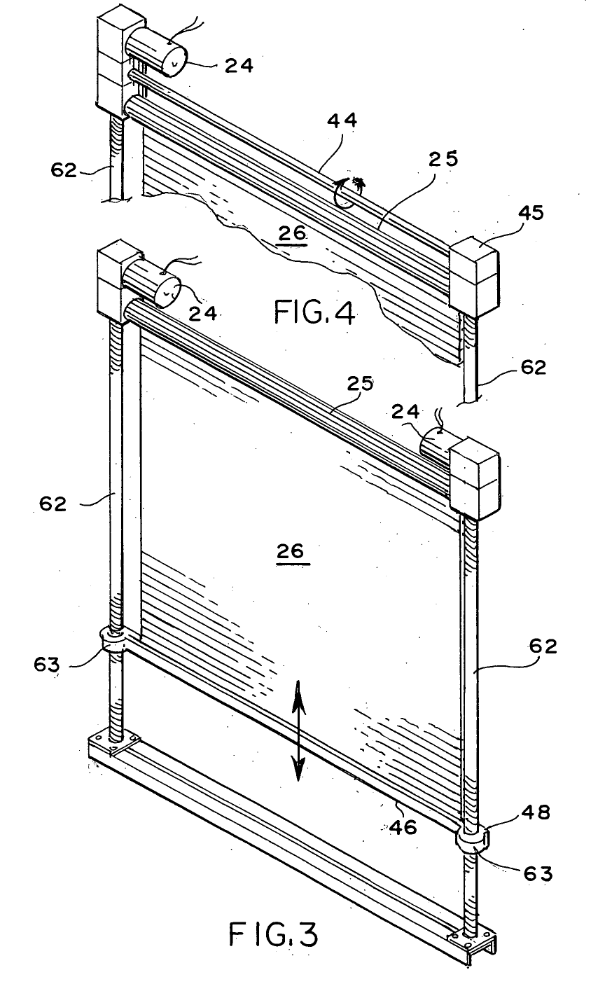

An alternate embodiment shutter 60 is disclosed in FIGS. 3 and 4. The alternate embodiment shutter 60 is similar in overall functionality of the shutter 60 is implemented through substituted or modified components. The shutter 60 differs from the shutter 10 in FIG. 1 in that instead of utilizing a belt drive system, the shutter 60 utilizes an endless screw drive system to raise and lower the shutter net 26. Specifically, endless screws are desirably situated or located within the left and right guide channels 14 and 15. Each end of the lower profile 46 or beam 48 is adapted to threadably engage a respective threaded nut. The motors 24 will impart a rotational movement to each of the endless screws 62. Accordingly, when each endless screw rotates, the threadably engaged lower profile 46 or the beam 48 moves along the length of both the endless screws 62, which causes the shutter net 26 to move up or down.

With continuing reference to FIG. 2, a shutter system 70 for use with the shutter system 10 is disclosed. In the desirable embodiment, the shutter system 70 may include a computer control 72 interfaced with a variety of subsystems. For example, the computer control 72 may be communicatively connected to a wind sensor or anemometer 76, a sound alarm 78, an in-house alarm system 80 and an external communication network, such as the internet 82. The system may also be connected to an entrapment protection relay of the proprietary design.

The computer control 72 my be embodied as a dedicated computing device or a multi-functional computer, such as a personal computer system. The wireless functioning of the system is very unique in that the wireless system controls the window shutter system remotely by way of an IP internet control from remote locations. The system may also be programmed to dial 911 or other authorities including the owner (in case of an absence) when unauthorized intrusion is sensed. The computer control 72 is responsible for transmitting control signals to the motors 24, which in turn, causes the motors 24 to lower or raise the shutter 26. The wind sensor 74 my be configured to detect the intensity and the direction of the wind around the home or the building structure. Based upon predetermined wind speeds corresponding to the severity of storms, hurricanes and other inclement weather conditions, the shutter net 26 can automatically be lowered if increased wind conditions are sensed. Once the increased wind condition has subsided, the shutter net 26 can be raised again. The UV intensity sensor 76 may be configured to determine the amount or intensity of sunlight directed toward the home or building. The intensity sensor 76 may be embodied as an omni-directional sensor or individual sensor placed in various sunlight or UV intensity levels corresponding to unacceptable UV levels that may be harmful to furniture or individuals, the shutter net 26 can be lowered automatically if such levels are sensed.

It is to be understood that the computer control 72 can control individual shutters 10 covering respective windows 12 in the home. This allows independent lowering and raising of each of the shutter nets 26 of the home as needed or desired. For example, if intense sunlight has been detected by the UV intensity sensor as emanating from only a particular direction, then the computer control 72 may cause only the shutter nets 26 on windows facing that particular direction to be lowered.

The alarm system 80 may be configured such that if a break-in in the home is detected by the alarm system's own sensors, the alarm system 80 immediately indicates to the computer control 72 the break-in, whereby all the shutters in the home are automatically lowered. For example, if proximity sensors, such as IR sensors, detect intrusion upon the property, each of the shutter nets 26 may be lowered in anticipation of a break-in of the home or to prevent further intrusion thereof. The computer control 72 may also be configured to activate the sound alarm 78 and transmit an increased decibel sound if the window 12 is blocked when an attempt is made to lower the shutter 26.

The surface of the shutter net 26 includes a frequency that is readily measurable. Various forms of destruction such as piercing, cutting, stretching, etc., of the shutter net 26 results in a measurable change in frequency thereof. Accordingly, a change in frequency may be indicative of severe weather, break-in vandalism, etc. A sensor (not shown) may be mounted on the shutter 10 to monitor the frequency of the shutter net 26 while it is deployed. Desirably, the sensor may be communicatively connected to the computer control 72 and is configured to detect a tolerable amount of deviation in frequency, as defined by an acceptable range, which would not be indicative to the computer control 72 that the shutter net 26 is damaged. However, any frequency changes that fall outside of the accepted minimum and maximum frequencies would cause the sensor to signal to the computer control 72 that any one of the exemplary forms of destruction of the shutter net 26 has occurred. Additionally, the aforementioned sound alarm 78 may be activated if the computer control 72 senses any such attempted destruction of the shutter net 26.

FIGS. 5-7 illustrate a safety system that will prevent the shutter net 26 from moving downwardly if any obstruction 82 is detected in its downward movement. The lower beam 48 of the shutter structure, for example, has a soft rubber half or full circle tube 82 attached on its underside. In alignment with the half or full circle of the tube 82 on one side of the beam or profile 48 there is located an infrared sending unit 80 which emits an infrared light ray or light through the opening in the half circle tube. The infrared light may also be replaced by a laser or any other light band. On the other side of the beam 48 there is a reflector 63 which receives the infrared light ray and confirms through appropriate wiring that there is no obstruction under the beam 48 during its downward movement. However, if there is an obstruction 83, such as a child, and animal or any item that was forgotten on the window sill, this obstruction will compress the soft rubber tube at that point and interrupt the infrared light beam. Again, through appropriate wiring the driving motors 24 will be stopped and the obstruction may be removed. The tube 82 may also be made of silicone or other soft pliable material

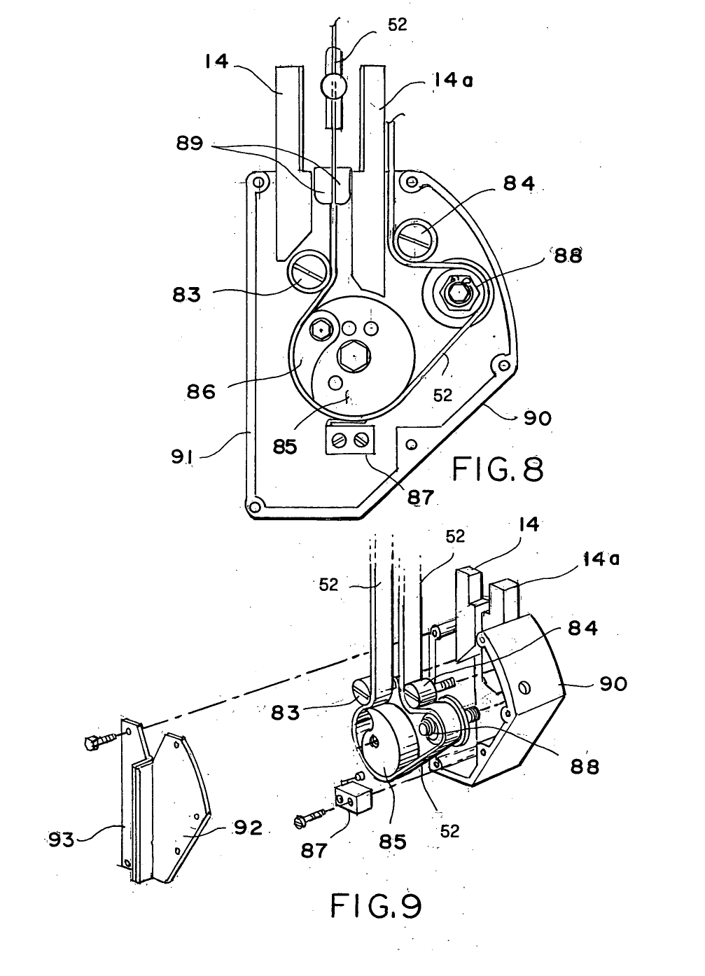

FIGS. 8 and 9 show a different embodiment of stopping the downward movement of the shutter net with its lower beams 46 and 48. To this end, FIG. 8 shows the two side guides 14 and 14a which are part of the lateral guides 14 and 15 which are formed as U-shaped profiles. The shutter screen is guided through guide bars 89 prior to entering the casing made up of profiles 90 and 91. The ends of the casing made up of the profiles 90 and 91 may be closed by cover plates 92 and 93. Within the profile made up of the front and back casings or profiles 90 and 91 there are located stop rollers 85 located on either side of the guides 14 and 15. Each of the stop rollers has a recess 86 therein. The stop roller 85 is driven by the belt 52 as which is trained around the stop roller 85 by a first deflection roller 83 which guides the belt 52 toward or around the first deflection roller 83. From the stop roller 85 the belt 52 is further guided around a second guide roller 88 and then around a third guide roller 84 and then upward again to its descending lower beam 48. The second guide roller may be used to activate the shutter net in its up and down movement by applying an appropriate tool thereon, such as a hand crank (not shown). The recess 86 is instrumental in stopping the downward movement of the shutter net when the lateral pin 54 (FIGS. 1 and 2) reaches its predetermined position when the net 26 is moving downwardly. The movement of the net 26 and the rotation of the stop roller 85 are synchronously timed in such a manner that when the lower beam 46 or 48 with its lateral extension pin 54 reaches its lowest position, the lateral pin 54 will enter the recess 86 and be locked therein. At the same time, the micro switch 87 detects the union between the lateral pin and the recess 86 in the stop roller 85 and shuts off the electric power to the motors 24 after a predetermined delay in time. The delay in time is instrumental in tensioning the net or shield 26. The tensioning will result in a stretching of the net to some degree so that a deflection of the net in the range of not more than 3-10 cm can be controlled when impacted by flying debris.

The shutter 10 or shutter system 70 may incorporate a battery backup system or other uninterruptible power supply to, allow raising and lowering of the shutter net 26 in the absence of traditional power supplied to the home or the building. For example, in a storm in which the traditional power supplied to the home has been interrupted, the shutter net 26 may still fully function. The shutter system 70 may be configured to automatically maintain the shutter net 26 in a lowered position until normal power has been restored to the home.

The computer control 72 may be communicatively connected through the internet 82 to a service provider secure website (not shown) that provides various status data relating to the shutter system 70 (e.g. verification of whether the shutter net 26 is in a raised or lowered position). Additionally, a homeowner may access the website to manually initiate remote closing or opening of the shutter net 26. Although the operation of the shutter 10 has been described in the context of automatic use, it is to be understood that the shutter 10 may also be operated manually, via a button or remote control or by hand cranking including a winch.

The following discussion pertaining to the system components associated with the related aforementioned shutter 10 and the alternate embodiment shutter 60, however it should be realized that the system components may be integrated with other shutters.

The present invention has been described with reference to the preferred embodiments. Modifications combinations and alterations will occur to others upon reading the preceding detailed description. It is intended that the invention be construed as including all such modifications, combinations and alterations.

What I claim is:

1. An automatic protective shutter system in combination with openings in a building to cover said openings, said shutter system includes a shutter net for each of said openings including means for operating said shutter net to open and close said openings including means for operating said shutter net in response to various atmospheric conditions and in response to human intervention conditions.

2. The automatic shutter system of claim 1, wherein said means for operating is locally controlled.

3. The automatic shutter system of claim 1, wherein said means for operating is remotely controlled.

4. The automatic shutter system of claim 1, wherein one of said atmospheric conditions is the incidence of high wind occurrences.

5. The automatic shutter system of claim 1, wherein one of said conditions is the presence of high Ultra Violet light.

6. The automatic shutter system of claim 1, wherein one of said conditions is the incidence of human tampering with said shutter net.

7. The automatic shutter system of claim 1, wherein said shutter is stored on a windup roller, said windup roller is mounted above each of said openings.

8. The automatic shutter system of claim 1 including guide channels on each side of said openings to guide edges of said shutter net contained therein.

9. The automatic shutter system of claim 7 including an electric motor for driving said windup roller in an up or down manner.

10. The automatic shutter system of claim 8 including belts located in said guide channels to aid in deploying said shutter, one end of each of the belts is operatively attached to said windup roller by way of a belt wheel.

11. The automatic shutter system of claim 10, wherein each of said belt wheels has an interior spring system.

12. The automatic shutter system of claim 8 including a bottom profile having means for attaching said shutter net thereto, each end of said profile is contained within each of said guide channels to move therein.

13. The automatic shutter system of claim 12, wherein said bottom profile consists of two corrugated beams trapping said shutter net there between

14. The automatic shutter system of claim 12 including means for locking said profile in place when said shutter net is fully deployed.

15. The automatic shutter system of claim 14 including means for stretching said shutter net after having been fully deployed.

16. The automatic shutter system of claim 12 including means for detecting when said shutter net is fully deployed including said profile.

17. The automatic shutter system of claim 14, wherein said means for locking is a solenoid.

18. The automatic shutter system of claim 14, wherein said means for locking includes a locking roller driven by said shutter net.

19. The automatic shutter system of claim 12 including belt guide rollers attached to said bottom profile at each end thereof having another end of said belts attached thereto and having means therein for biasing said belts in a windup direction.

20. The automatic shutter system of claim 1, wherein said means for operating said shutter net is an endless screw drive system including endless screws placed within guide channels located at lateral sides of each of said openings.

21. The automatic shutter system of claim 20 including a bottom profile having means thereon for attaching said shutter net thereto including a threaded nut located at each end of said bottom profile and each receiving one of said endless screws therein.

22. The automatic shutter system of claim 1, including means for detecting an obstacle below said shutter net when said shutter net is in a downward movement.

23. The automatic shutter system of claim 22, wherein said means for detecting is an infrared light system being interrupted when said shutter net encounters said obstacle.

24. The automatic shutter system of claim 1 including a battery back-up in case of traditional power failure.

25. The automatic shutter system of claim 1, wherein said means for operating is done manually.

26. The automatic shutter system of claim 1 including an audible alarm system when said shutter net is being interrupted.

27. The automatic shutter system of claim of claim 3 wherein said means for remotely operating is by way of the internet.

28. The automatic shutter system of claim 6, wherein said human tampering is detected by a proximity sensor.

29. A method of protecting building openings including the steps of placing a protective shutter system on an outside of said openings, said shutter system including a movable and yieldable shutter net, monitoring the ambient atmosphere for excessive wind movement, monitoring the incident of excessive high ultraviolet rays and monitoring a human tampering with said shutter net, moving said shutter net to close any of said openings upon said monitoring resulting in a positive feed back.

30. The method of claim 29 including the step of monitoring from a local station.

31. The method of claim 29 including the step of monitoring from a remote location.

32. The method of claim 29, wherein said step of monitoring of human tampering includes the step of monitoring the frequency of the surface of said shutter net.

33. The method of claim 31, wherein said step of monitoring from a remote location involves the step of using a computer including the step of a connection via the internet.

34. A woven hurricane shutter net having approximately 13.5 warp strands per inch and approximately 10 weft strands per inch leaving an open area of interstices between said warp and weft strands of 32%.

35. The hurricane shutter net of claim 34, wherein said warp strands consist of 1400-1500 denier of an aramid material and said weft strands are each a twisted 7 strand multi-filament twine with each filament being of a 0.30 mm to 0.35 mm size.

36. The hurricane shutter net of claim 34 including a coating to prevent a degradation of said strands and aids in an 80% penetration of an ultraviolet radiation while allowing a semi-transparent vision through said net.
